(19) United States
(12) Patent Application Publication
(10) Pub. No.: US 2013/0081483 A1
(43) Pub. Date: Apr. 4, 2013

(54) BIOCHIP

(71) Applicants: Se Hoon JEONG, Seoul (KR); Bo Sung KU, Suwon (KR)

(72) Inventors: Se Hoon JEONG, Seoul (KR); Bo Sung KU, Suwon (KR)

(73) Assignee: SAMSUNG ELECTRO-MECHANICS CO., LTD.

(21) Appl. No.: 13/362,946

(22) Filed: Jan. 31, 2012

(30) Foreign Application Priority Data
Sep. 30, 2011 (KR) 10-2011-0099798

(51) Int. Cl. B01L 3/00

(52) U.S. Cl. 73/864.91

(57) ABSTRACT

There is provided a biochip including a plate member, and a pillar member formed on the plate member and including a surface to which biomaterials are attached, wherein the surface includes an outer wall preventing the biomaterials from flowing outwardly therefrom.

### CROSS-REFERENCE TO RELATED APPLICATIONS

This application claims the priority of Korean Patent Application No. 10-2011-0099798 filed on Sep. 30, 2011, in the Korean Intellectual Property Office, the disclosure of which is incorporated herein by reference.

### BACKGROUND OF THE INVENTION

1. Field of the Invention

The present invention relates to a biochip used for biomaterial experimentation, and more particularly, to a biochip capable of improving the adhesion of biomaterials attached to a pillar member of the biochip.

2. Description of the Related Art

A biochip is used to test biomaterial components (for example, DNA, a protein, an enzyme, another ligand, or the like) and to determine biological reactions between the biomaterial components and test substances. The biochip has a predetermined area or surface to which biomaterials or test substances may be applied and attached.

The surface of a biochip, according to the related art, is a simple flat, smooth surface. Consequently, biomaterials applied to the biochip have tended to flow in one direction, according to a shape of the pillar member, rather than being stably fixed in a position desired by an experimenter. This phenomenon causes a quantitative deviation in the biomaterial applied to the biochip, thereby degrading testing precision.

Further, biochips, according to the related art, do not include a structure able to stably receive biomaterials applied through a mechanism such as pipette, and therefore, bubbles may be caused when biomaterials collide with the surface of the biochip. These bubbles may have a negative impact on the viability of the biomaterials, thereby degrading the testing precision thereof.

Therefore, in order to accurately obtain the test results of the biomaterials, a need exists for the development of a biochip having a structure allowing biomaterials to be stably attached thereto.

### SUMMARY OF THE INVENTION

An object of the present invention provides a biochip capable of suppressing a generation of bubbles during an application of biomaterials to a pillar member or a process of dropping biomaterials onto the pillar member while improving adhesion therebetween.

According to an embodiment of the present invention, there is provided a biochip, including: a plate member; and a pillar member formed on the plate member and including a surface to which biomaterials are attached, wherein the surface includes an outer wall preventing the biomaterials from flowing outwardly therefrom.

The surface may further include a protrusion allowing the biomaterials to be uniformly spread thereon.

The protrusion may be formed at a center of the surface.

The protrusion may be formed to be higher or lower than the outer wall from the surface.

The protrusion may include a plurality of protrusions formed on the surface, the plurality of protrusions having a predetermined distance therebetween.

The protrusion may have a hemispherical shape.

The surface may further include protruding pieces extending radially from the center of the surface.

The surface may further include inner walls formed inside of the outer wall.

The inner walls may be formed to have predetermined distances toward the center of the surface from the outer wall.

The surface may be a convex surface or a concave surface.

The surface may further include a plurality of grooves to increase an area in contact with the biomaterials.

The surface may be a convex surface or a concave surface.

The surface may further include the protruding pieces extending radially from the center of the surface.

The plate member may be integrally formed with the pillar member.

The plate member and the pillar member may be injection-molded.

The plate member and the pillar member may be formed of a plastic material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a biochip according to a first embodiment of the present invention;

FIG. 2 is a partial enlarged view of a pillar member in the biochip shown in FIG. 1;

FIG. 3 is a cross-sectional view showing a state in which biomaterials are applied to the pillar member shown in FIG. 2;

FIG. 4 is a perspective view of a pillar member of a biochip according to a second embodiment of the present invention;

FIG. 5 is a cross-sectional view showing a state in which biomaterials are applied to the pillar member shown in FIG. 4;

FIG. 6 is a perspective view of a pillar member of a biochip according to a third embodiment of the present invention;

FIGS. 7 and 8 are a perspective view and a cross-sectional view of a pillar member of a biochip according to a fourth embodiment of the present invention, respectively;

FIGS. 9A through 12 are views showing a pillar member of a biochip according to a fifth embodiment of the present invention; and

FIGS. 13 through 15 are cross-sectional views showing a pillar member of a biochip according to a sixth embodiment of the present invention.

### DETAILED DESCRIPTION OF THE INVENTION

Embodiments of the present invention will be described in detail with reference to the accompanying drawings.

In describing the present invention below, terms indicating components of the present invention are named in consideration of functions of each component, and these terms should not be understood as being limited to technical components of the present invention.

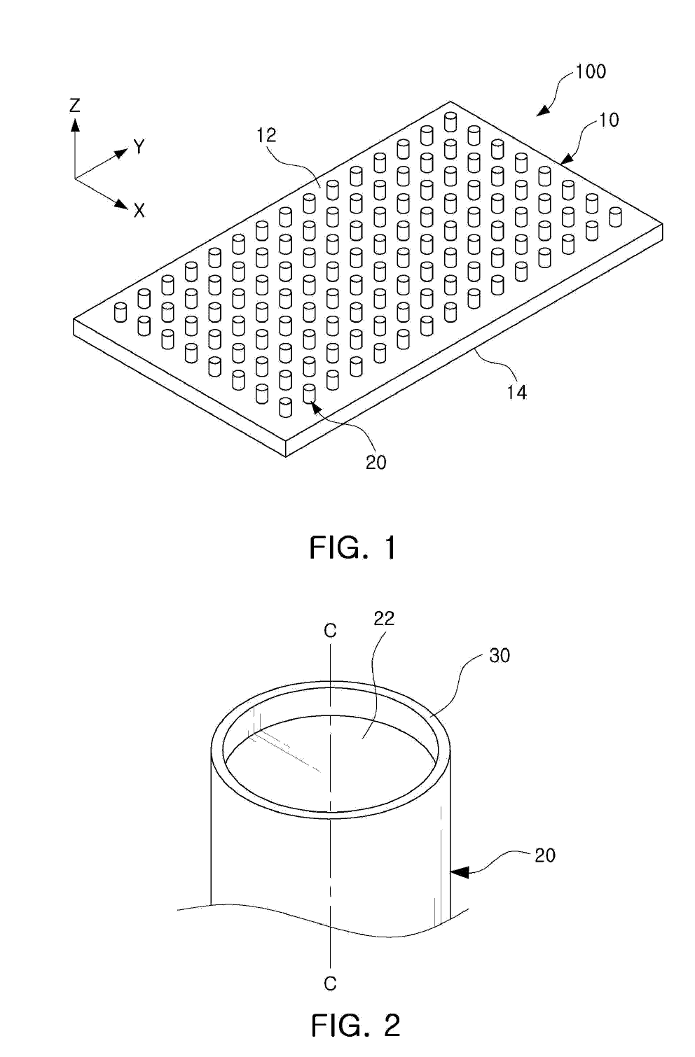

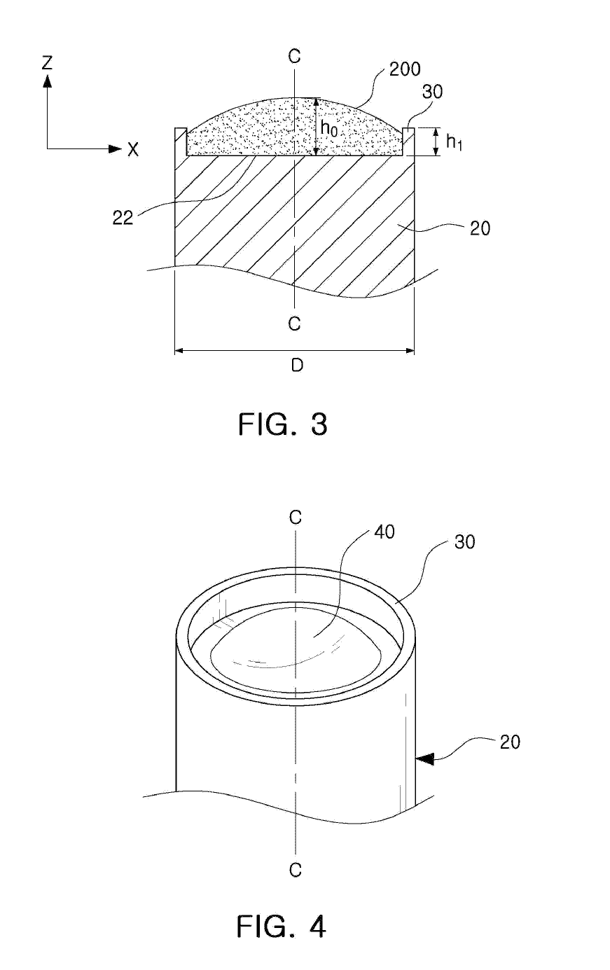

FIG. 1 is a perspective view of a biochip according to a first embodiment of the present invention, FIG. 2 is a partial enlarged view of a pillar member in the biochip shown in FIG. 1, and FIG. 3 is a cross-sectional view showing a state in which biomaterials are applied to the pillar member shown in FIG. 2.

### FIRST EMBODIMENT

A biochip 100 according to the first embodiment of the present invention may include a plate member 10, a pillar member 20, and an outer wall 30.

The plate member 10 may be a generally thin rectangular sectional member and may form a biochip module for testing biomaterials by being coupled with another member. A first surface 12 and second surface 14 of the plate member 10 may be a plane, parallel with an X-Y plane based on the directions of FIG. 1. The plate member 10 maybe formed of a plastic material. The plate member 10 formed of the plastic material may be mass-produced by injection molding, thereby reducing manufacturing costs as compared with a biochip formed of a glass material. Further, the plate member 10 formed of the plastic material is relatively lighter and has a lower level of brittleness than the biochip formed of the glass material, such that the plate member 10 may be easily handled and the possibility of the generation of damage to the plate member due to carelessness may be reduced.

However, the plate member 10 is not limited thereto. For example, the plate member 10 may be formed of polymethyl methacrylate (PMMA), polycarbonate (PC), polystyrene (PS), cyclic olefin copolymer, polynorbonene, styrene-butadiene copolymer (SBC), or acrylonitrile butadiene styrene.

The pillar members 20 may be formed on a first surface 12 of the plate member 10. In this case, the pillar members 20 may protrude from the first surface 12 of the plate member 10 in a vertical direction (that is, a +Z-axis direction) and may be arranged to have a predetermined interval therebetween in widthwise and lengthwise directions (that is, X-axis and Y-axis directions) of the plate member 10. The pillar members 20 arranged as described above may have the same length and may have any one of circular, quadrangular, and polygonal sectional shapes. Further, a top surface 22 of the pillar member 20 may be machined to facilitate the attachment of the biomaterials thereto or may be coated with an auxiliary material assisting in the attachment of the biomaterials.

The pillar member 20 may have a predetermined diameter D as shown in FIG. 3. In this case, the diameter D of the pillar member 20 may be determined within a range having an upwardly protruding shape by a surface tension of the biomaterials 200 fixed to the surface 22.

The outer wall 30 may be formed on the surface 22 of the pillar member 20. In more detail, the outer wall 30 may be protruded in the +Z-axis direction along the edge of the surface 22. The outer wall 30 may prevent the biomaterials received on the surface 22 from flowing outwardly. Meanwhile, a height h1 of the outer wall 30 may be determined in a range allowing a height h0 of the biomaterials 200 to be maximized on the surface 22. However, the height h1 of the outer wall 30 may be varied according to the biomaterials 200 to be tested.

For reference, in the embodiment of the present invention, the biomaterials may refer to various biomolecules or biomaterials but are not limited thereto. For example, the biomaterials maybe nucleic acid arrangement such as RNA, DNA, or the like, peptide, protein, lipid, organic or inorganic chemical molecules, virus particles, procaryotic cells, organelle, or the like. In addition, the types of cells are not particularly limited and may be, for example, microorganism, plant and animal cells, cancer cells, neuron cells, cells in blood vessel, immune cells, or the like.

As described above, according to the embodiment of the present invention, the outer wall 30 allows the biomaterials 200 on the surface 22 to be centered (portion shown by line C-C) of the pillar member, thereby improving the testing precision of the biomaterials 200.

In addition, according to the embodiment of the present invention, the contact area between the pillar member 20 and the biomaterials 200 may be increased by the outer wall 30, thereby effectively fixing the biomaterial 200 to the pillar member 20.

Next, another embodiment of the present invention will be described. For reference, the components described in the first embodiment will be denoted by the same reference numerals and a description thereof will be omitted.

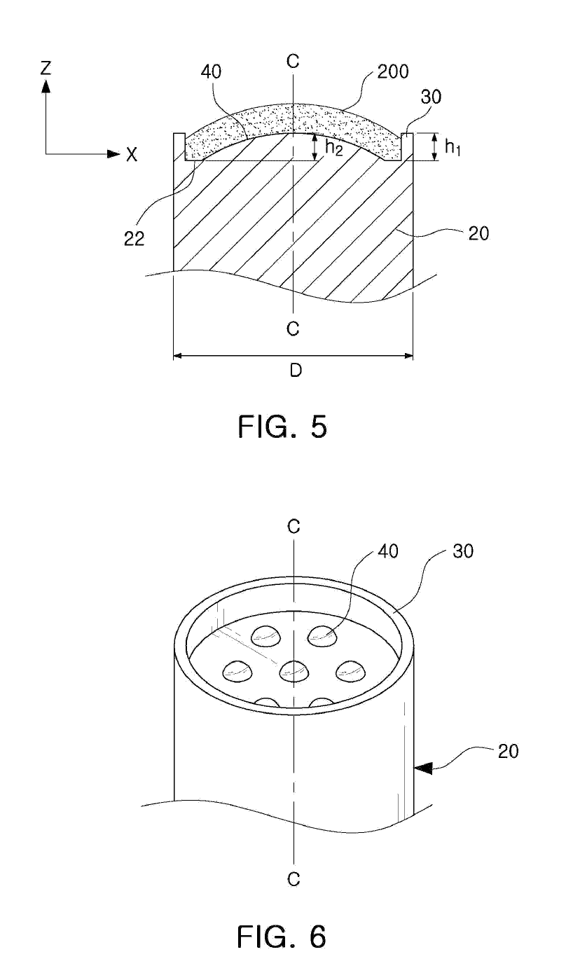

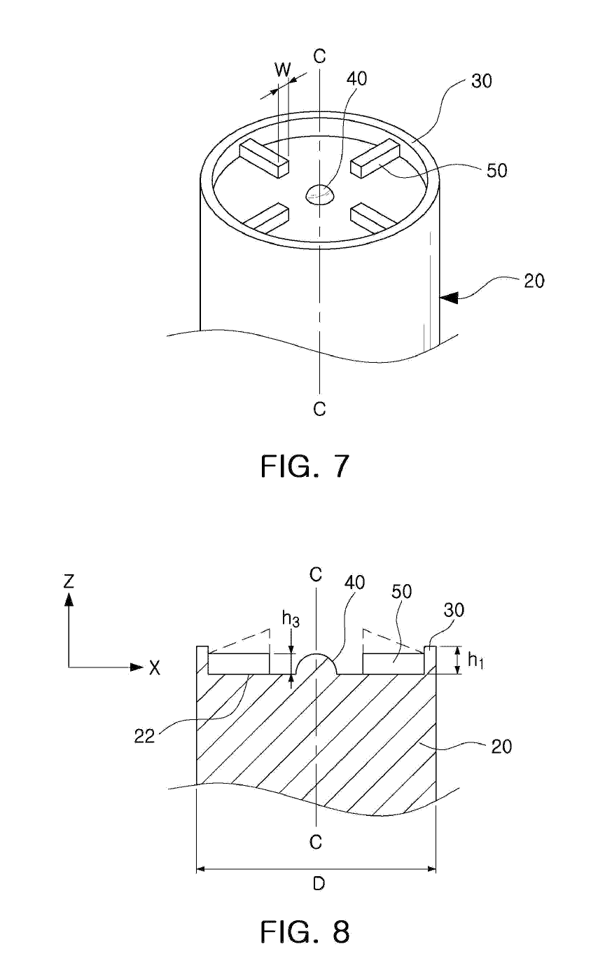

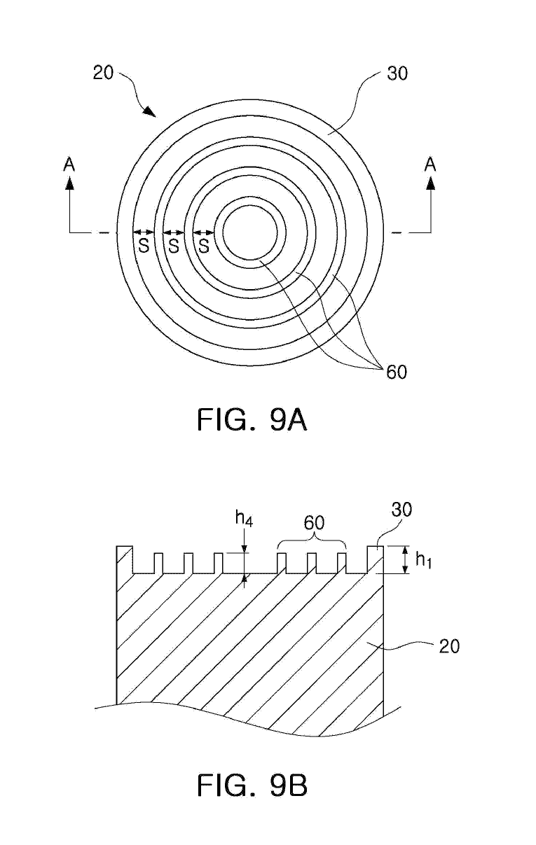

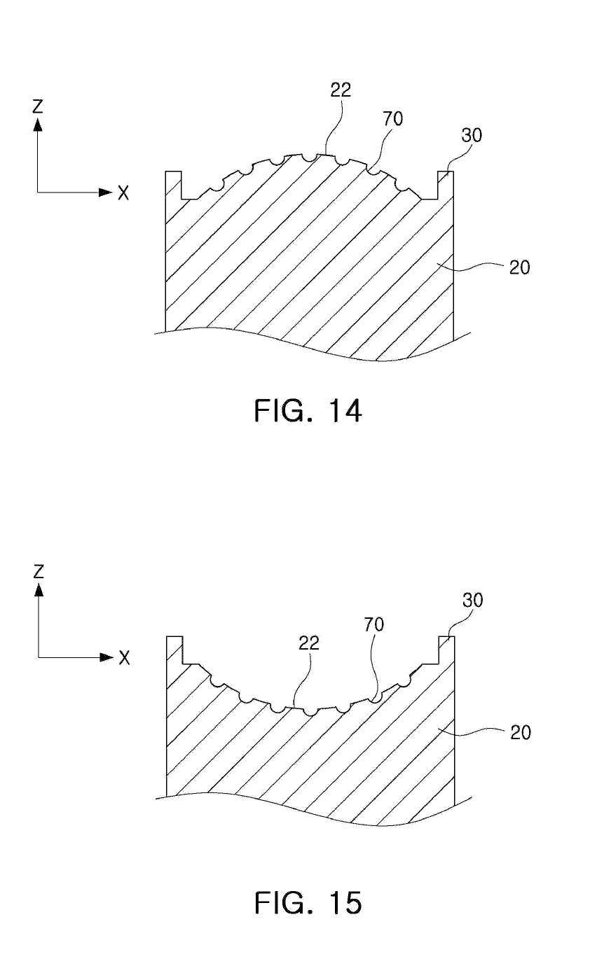

FIG. 4 is a perspective view of a pillar member of a biochip according to a second embodiment of the present invention, FIG. 5 is a cross-sectional view showing a state in which the biomaterials are applied to the pillar member shown in FIG. 4, FIG. 6 is a perspective view of a pillar member of a biochip according to a third embodiment of the present invention, FIGS. 7 and 8 are a perspective view and a cross-sectional view of a pillar member of a biochip according to a fourth embodiment of the present invention, FIGS. 9A through 12 are views showing a pillar member of a biochip according to a fifth embodiment of the present invention, and FIGS. 13 through 15 are cross-sectional views showing a pillar member of a biochip according to a sixth embodiment of the present invention.

### SECOND EMBODIMENT

The second embodiment of the present invention will be described with reference to FIGS. 4 and 5.

The biochip according to the second embodiment of the present invention may be different from the first embodiment, in that the biochip includes protrusions 40.

The protrusion 40 may be formed on the surface 22 of the pillar member 20. In more detail, the protrusion 40 may be disposed on a central axis C-C of the pillar member 20. In this case, the protrusion 40 may have a height h2 as shown in FIG. 5. The height h2 of the protrusion 40 maybe equal to the height h1 of the outer wall 30 or may be lower than the height h1 of the outer wall 30. However, the height h2 of the protrusion 40 may be higher than the height h1 of the outer wall 30.

In this embodiment of the present invention, the protrusion 40 is formed on the surface 22 of the pillar member 20 and therefore, the biomaterials 200 may be easily formed in an upwardly protruding shape suitable for testing. Therefore, it may be advantageous in allowing the biomaterials 200 having low viscosity to be convexedly protruded.

Further, the protrusion 40 according to the embodiment of the present invention serves to allow the biomaterials 200 dropped onto the surface 22 of the pillar member 20 to be spread over the surface 22, thereby allowing the thickness of the biomaterials 200 being applied to be uniform. Therefore, it may be advantageous in improving the testing precision of the biomaterials 200.

### THIRD EMBODIMENT

The third embodiment of the present invention will be described with reference to FIG. 6.

The biochip according to the third embodiment of the present invention maybe different from the second embodiment, in that the biochip includes a plurality of protrusions 40. That is, according to this embodiment of the present invention, the plurality of protrusions 40 may be formed on the surface 22 of the pillar member 20. In this case, the protrusions 40 may have any one of hemispherical, conic, pyramidal, and polygonal pillar shapes. Further, the protrusions 40 may be regularly or irregularly formed on the surface 22 of the pillar member 20.

In this embodiment of the present invention, the contact area between the surface 22 of the pillar member 20 and the biomaterials 200 may be increased through the plurality of protrusions 40.

### FOURTH EMBODIMENT

The fourth embodiment of the present invention will be described with reference to FIGS. 7 and 8.

The biochip according to the fourth embodiment of the present invention may be different from the above-mentioned embodiments, in that the biochip further includes protruding pieces 50.

In this embodiment of the present invention, the protruding pieces 50 may extend from the outer wall 30 toward the central axis of the pillar member 20 as shown in FIG. 7. Alternatively, although not shown, the protruding pieces 50 may extend from the center of the pillar member 20 toward the outer wall 30.

Further, the protruding pieces 50 may have the same width w toward the central axis from the outer wall 30. Alternatively, the protruding piece 50 may have the width w gradually reduced or increased toward the central axis from the outer wall 30.

Further, a height h3 of the protruding piece 50 may be constant from the outer wall 30 to the central axis C-C as shown in FIG. 8. Alternatively, the height h3 of the protruding piece 50 may be gradually increased toward the central axis C-C from the outer wall 30 as shown by a dotted line in FIG. 8.

Meanwhile, FIGS. 7 and 8 show that the protrusion 40 is formed on the pillar member 20, but the protrusion may be omitted if necessary.

In this embodiment of the present invention, it may be advantageous in dispersing the biomaterials 200 in all directions through the protruding pieces 50.

### FIFTH EMBODIMENT

The fifth embodiment of the present invention will be described with reference to FIGS. 9A through 12. For reference, FIG. 9A is a plan view of the pillar member 20 and FIG. 9B is a cross-sectional view taken along line A-A.

The biochip according to the fifth embodiment of the present invention may be different from the above-mentioned embodiments, in that the biochip further includes inner walls 60.

As shown in FIGS. 9A and 9B, the inner walls 60 may be formed in the outer wall 30 at a predetermined distance. In more detail, the plurality of inner walls 60 may be formed at the same distance S from the outer wall 30. Further, a height h4 of the inner wall 60 may be equal to the height h1 of the outer wall 30 or may be lower or higher than the height h1 of the outer wall 30.

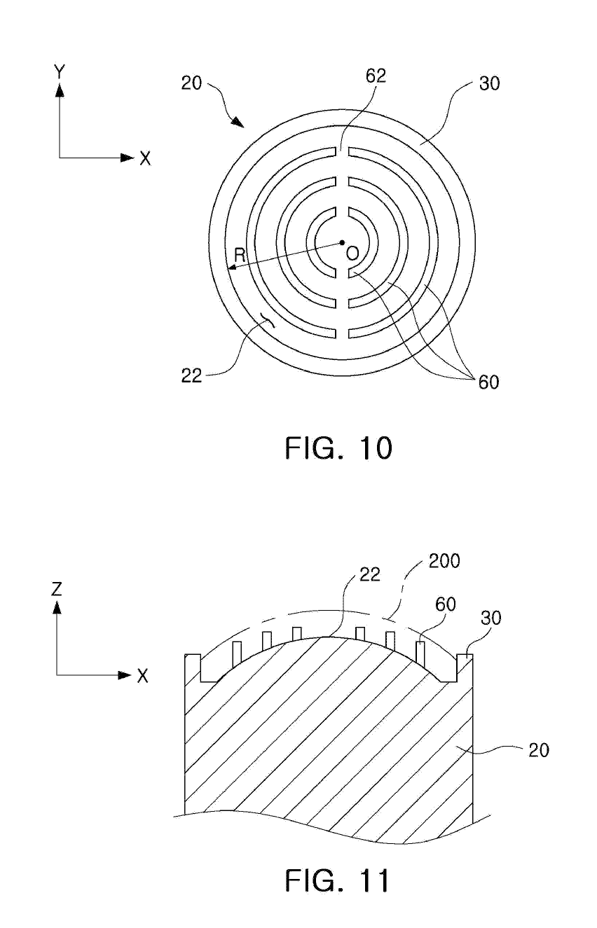

Further, the inner wall 60 may have at least one passage 62 so as to allow for communication from the central point O (that is, a center of the outer wall 30 or inner wall 60) of the surface 22 in a radius direction (R direction) as shown in FIG. 10. For reference, FIG. 10 shows that each inner wall 60 is provided with two passages 62 but may be provided with three or more passages 62.

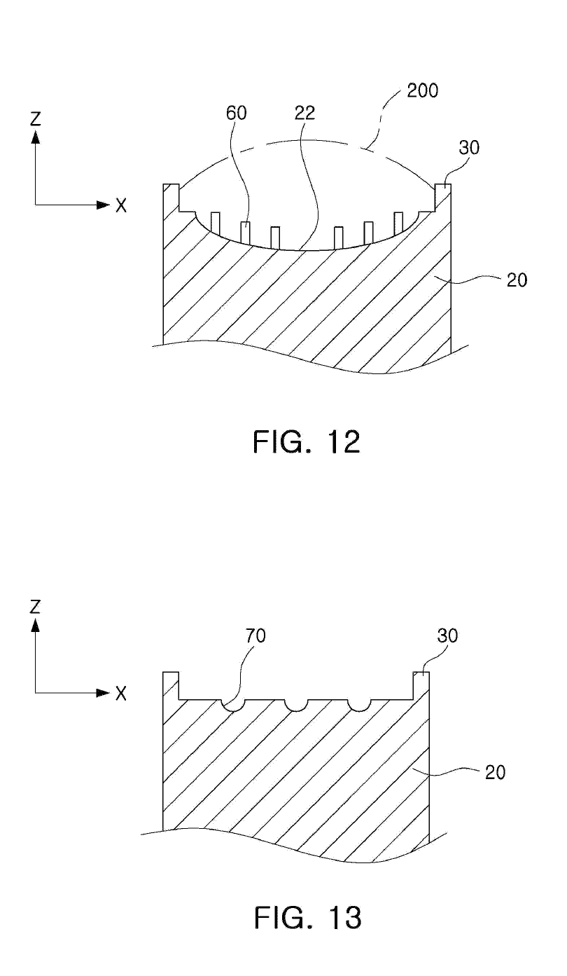

Meanwhile, the surface 22 of the pillar member 20 may have a convex shape or a concave shape as shown in FIGS. 11 and 12.

According to this embodiment of the present invention, the plurality of inner walls 60 are formed on the surface 22 of the pillar member 20, thereby stably fixing the biomaterials to the surface 22 of the pillar member 20.

### SIXTH EMBODIMENT

The sixth embodiment of the present invention will be described with reference to FIGS. 13 through 15.

The biochip according to the sixth embodiment of the present invention may be different from the above-mentioned embodiments, in that the biochip further includes grooves 70.

The grooves 70 may be regularly or irregularly formed in the surface 22 of the pillar member 20 and may increase the contact area between the biomaterials and the pillar member 20.

As set forth above, the biochip according to the embodiments of the present invention can suppress the phenomenon of biomaterials flowing outwardly from the test surface by allowing the biomaterials to be collected onto a specific surface.

In addition, the biochip according to the embodiments of the present invention can suppress the generation of bubbles due to the collision between the surface of the biochip and the biomaterials by forming protrusions and protruding pieces on the surface of the biochip.

Further, the biochip according to the embodiments of the present invention may allow the bio materials to be in a protruding shape suitable for testing since protrusions are formed at the center of the surface.

Therefore, testing precision can be enhanced.

While the present invention has been shown and described in connection with the embodiments, it will be apparent to those skilled in the art that modifications and variations can be made without departing from the spirit and scope of the invention as defined by the appended claims.

What is claimed is:

1. A biochip, comprising:
a plate member; and
a pillar member formed on the plate member and including a surface to which biomaterials are attached,
wherein the surface includes an outer wall preventing the biomaterials from flowing outwardly therefrom.

2. The biochip of claim 1, wherein the surface further includes a protrusion allowing the biomaterials to be uniformly spread thereon.

3. The biochip of claim 2, wherein the protrusion is formed at a center of the surface.

4. The biochip of claim 3, wherein the protrusion is formed to be higher or lower than the outer wall from the surface.

5. The biochip of claim 2, wherein the protrusion comprises a plurality of protrusions formed on the surface, the plurality of protrusions having a predetermined distance therebetween.

6. The biochip of claim 2, wherein the protrusions have a hemispherical shape.

7. The biochip of claim 1, wherein the surface further includes protruding pieces extending radially from a center of the surface.

8. The biochip of claim 1, wherein the surface further includes inner walls formed inside of the outer wall.

9. The biochip of claim 8, wherein the inner walls are formed to have predetermined distances toward a center of the surface from the outer wall.

10. The biochip of claim 8, wherein the surface is a convex surface or a concave surface.

11. The biochip of claim 1, wherein the surface further includes a plurality of grooves to increase an area in contact with the biomaterials.

12. The biochip of claim 11, wherein the surface is a convex surface or a concave surface.

13. The biochip of claim 11, wherein the surface further includes protruding pieces extending radially from a center of the surface.

14. The biochip of claim 1, wherein the plate member is integrally formed with the pillar member.

15. The biochip of claim 14, wherein the plate member and the pillar member are injection-molded.

16. The biochip of claim 1, wherein the plate member and the pillar member are formed of a plastic material.
